(19) United States
(12) Patent Application Publication
(10) Pub. No.: US 2026/0030450 A1
(43) Pub. Date: Jan. 29, 2026

(54) Interdisciplinary Synergy Through Domain-Specific Multi-Modal LLM

(71) Applicants: Somayeh Bakhtiari Ramezani, Starkville, MS (US); Amin Amirlatifi, Starkville, MS (US)

(72) Inventors: Somayeh Bakhtiari Ramezani, Starkville, MS (US); Amin Amirlatifi, Starkville, MS (US)

(21) Appl. No.: 19/279,052

(22) Filed: Jul. 24, 2025

Related U.S. Application Data
(60) Provisional application No. 63/675,021, filed on Jul. 24, 2024.

(51) Int. Cl. G06F 40/279; G06F 40/30; G06N 3/0475

(52) U.S. Cl. CPC G06F 40/279; G06F 40/30; G06N 3/0475

(57) ABSTRACT

A domain-specific multi-modal large language model (DMLLM) that adapts and provides specific, expert-level solutions and suggestions as a service in order to bridge the gap between different scientific disciplines and serve as an accelerated learning tool for a multidisciplinary team. A domain-specific multi-modal large language model (DMLLM) that combines the power of generative pre-trained transformers (GPTs) in order to extract, categorize, and present interdisciplinary scientific data and insights systematically. A system that incorporates multiple forms of data, including text, images, videos, and audio, to provide a more nuanced understanding of scientific literature.

### CROSS REFERENCES TO RELATED APPLICATION

PRIORITY OF U.S. PROVISIONAL PATENT APPLICATION Ser. No. 63/675,021, FILED Jul. 24, 2024, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

### Field of the Invention

The present invention pertains to a domain-specific multi-modal large language model (DMLLM) that can adapt and provide specific, expert-level solutions and suggestions as a service in order to bridge the gap between different scientific disciplines and serve as an accelerated learning tool for a multidisciplinary team.

### Brief Description of the Prior Art

### 1.1 The Technical Problem

In the modern scientific ecosystem, interdisciplinary research is more crucial than ever. As of 2023, the academic publishing landscape has witnessed a remarkable surge, with an annual publication of over 5.14 million academic articles. This growth trend is driven by several factors, including the expanding global community of researchers, increased access to research funding, a rising preference for open-access publishing, and ongoing advancements in publishing technologies that simplify the dissemination of research findings. This exponential growth in the volume of academic papers, exemplified by over 23% growth over the past five years (FIG. 1), presents both challenges and opportunities.

Researchers face the daunting task of navigating through this vast sea of knowledge, learning new concepts, assimilating recent research outcomes spanning different fields, and identifying areas where conflicting results exist between studies. In particular, the scientific literature is vast and often siloed within specific fields, making it arduous for researchers in various fields to gain a comprehensive understanding of each other's work. The need for effective tools and solutions to streamline interdisciplinary research and facilitate knowledge synthesis has never been more critical.

Scientists excel within their specific domains, but they often face considerable challenges in acquiring an in-depth understanding of terminology, concepts, and advancements in other pertinent disciplines.

As depicted in FIG. 2, different scientific and engineering fields are highly intertwined. The time and effort required to bridge these gaps in knowledge can be substantial. This poses a limitation that hampers the efficacy of interdisciplinary research, thereby decelerating the pace of scientific discovery. Information storage systems like databases or manuals store data but lack the ability to capture nuanced expertise developed over years of hands-on experience. This creates significant gaps, reducing efficiency and increasing operational risks, potentially leading to financial losses for organizations.

Recent studies highlight persistent issues in knowledge management systems. Existing knowledge management systems cannot grasp human context or provide insights like human experts. Another often overlooked issue is the loss of organizational knowledge when seasoned professionals leave. This ‘brain drain,’ can disrupt routines and cause inefficiencies or failures. While traditional Natural Language Processing (NLP) technologies struggled with the complexity of human language, recent advances in Large Language Models (LLMs) have improved sentiment analysis, text summarization, and machine translation. There is an importance in evaluating critical elements rather than the entire data corpus. Despite these advancements, much interdisciplinary data remains untapped due to content specialization and limitations in current LLMs.

Therefore, the need is urgent for an advanced, adaptable, and highly capable Domain-specific Multi-modal LLM (DMLLM) as a Service that can learn, adapt, and provide expert-level solutions and suggestions. Such a system would respond in a language in a scientist's native domain, explaining concepts from another domain, thus bridging the gap between different scientific disciplines. It can also act as a repository of organizational intelligence, preserving the wisdom of outgoing experts, thereby mitigating the adverse effects of brain drain. Additionally, this system could serve as an accelerated learning tool for new members of a multidisciplinary team, helping them rapidly acquire the requisite knowledge through interactive Q&A sessions or by locating relevant documents. Our proposed DMLLM system would also validate new insights based on the ground truth derived from existing validated knowledge, enhancing the reliability of the generated content.

### 1.2 Current Methods Used to Address the Problem

Current solutions for locating relevant papers and articles rely heavily on traditional search engines, databases, and repositories, which are fundamentally based on lexical criteria, wherein searches are conducted for specific keywords. While these text-based and keyword-driven approaches offer high-speed access to millions of scientific documents, they lack the intelligence to understand, categorize, and link cross-disciplinary knowledge in a way that can facilitate genuine scientific collaboration. Additionally, these platforms fall short of providing an in-depth, multi-modal, interdisciplinary understanding.

LLMs have created a paradigm shift, enabling searches to be conducted based on the underlying meaning of keywords. Generative AI encompasses a broad spectrum of foundation models designed to handle various types of data, including text, images, video, and audio. Before the advent of foundation models, training required the expensive task of labeling extensive datasets, which proved to be both time-consuming and prone to inaccuracies. Using LLMs to locate information is referred to as semantic or similarity search, as it can discern semantic relationships.

Specialized domain-specific models are essential for expert-level analyses, while LLMs like GPT-4 have limited training data, often lagging behind the latest information. For example, GPT-4's training data extends only up to September 2021. This gap poses challenges in providing up-to-date insights for scientific discoveries. LLMs require contextual data from various sources to provide meaningful results, or else they offer broad but unspecialized knowledge.

LLMs also face limitations in memory and “context”. For instance, GPT-3.5, with a 4K token size, can only handle short articles effectively. Although newer models like GPT-4 and PaLM2 offer larger token limits of 32K, they still operate within a context window, discarding excess data. When dealing with extensive source material, such as a 10-page scientific paper, this limitation becomes apparent. Augmentation techniques are employed to address these challenges, as further expanding token limits can lead to exorbitant costs.

A document can be divided into smaller units like paragraphs, sections, or chapters, which are then transformed into vectors. Specialized products like LangChain, Llama-index, or Unstructured typically manage this segmentation process. Using vectors and vector embeddings for predicting the next word or searching for relevant documents has been highly effective. Vectors represent words, text, images, sounds, or pictures as arrays of floating-point numbers that machine learning models can use. They capture semantic meanings and encompass “Multi-modal” aspects of various data types such as documents, video, audio, images, and source code. A well-trained LLM can distinguish between the vector representations of different contexts, even if the words are exactly the same.

Vector search finds the closest neighbors in the dataset to the input vector, assessing proximity through techniques like Euclidean distance, cosine angle, or dot product. The Prompt provided by the user is also transformed into a vector and compared to the vectors generated for document chunks. Top k chunks of data representing the prompt vector, along with the prompt, are passed to the LLM for in-context response generation, even accommodating text or images. This semantic-rich approach enhances the exploration of structured and unstructured data.

Vector search excels in discovering related information, even without exact keyword matches in the inverted index. Conversely, keyword or full-text search excels in precision and improves initial result quality through semantic ranking. Keyword search shines in specific situations like queries involving product codes, scientific terminology, dates, or personal names, where pinpointing exact matches is crucial. Hybrid search combines the strengths of both vector and keyword search, leveraging their respective advantages. Extensive benchmark testing on real-world and benchmark datasets has proven the substantial advantages of hybrid search with semantic ranking in terms of search relevance. An efficient approach combines both keyword and vector embeddings search for comprehensive document exploration. To the best of our knowledge, there are no solutions available that handle multi-modal cross-disciplinary scientific content.

### SUMMARY OF THE INVENTION

The present invention proposes to bridge this interdisciplinary knowledge gap by developing a Domain-specific Multi-modal LLM (DMLLM) that combines the power of generative pre-trained transformers (GPTs) to extract, categorize, and present interdisciplinary scientific data and insights systematically. This system of the present invention incorporates multiple forms of data, including text, images, videos, and audio, to provide a more nuanced understanding of scientific literature. The present invention aims to build a secure and scalable system that not only fetches data but understands and correlates it, offering unprecedented facilitation of a context-rich interdisciplinary research knowledge base.

The hybrid keyword and semantic search Retrieval-Augmented Generation (RAG) architecture of the present invention will ingest scientific documents, extract text and other data types like images, videos, and audio to build a comprehensive, multi-modal database. This system will be continually updated with Domain-Specific Embeddings (DSE), ensuring a robust and evolving data corpus.

Upon ingesting new data, different types of content (e.g., texts, images, . . . ) are extracted and treated as individual documents. The vector embedding pertaining to each document is generated and persisted in a vector database, and in PostgreSQL, which is a vector enabled DBMS. Additionally, a summary of the document, along with relevant keywords are automatically generated and stored alongside the vector embeddings and document's metadata. The unique features setting our architecture apart are its hierarchical, similarity-based distributed multi-models, together with the summaries and keywords pertaining to each document offering a level of interdisciplinary understanding currently unparalleled in the scientific community.

The present invention envisions a revolutionary approach that goes far beyond the capabilities of current text-based search engines and databases. For instance, systems like Google Scholar or PubMed are designed for text retrieval and are insufficient for nuanced scientific query processing (Wang et al., 2018). The DMLLM of the present invention not only understands the semantics of scientific literature but also integrates various data modalities. It will be trained to not just process queries but to understand context, infer intent, and even capture sentiment and latent variables, thus providing a far richer and more actionable set of insights than existing solutions. Users can direct the model to only retrieve data relevant to a particular data source. They can also identify a main domain as their area of expertise and request information pertaining to another scientific domain to be presented in a way they would be able to relate to. In the present case, the system of the present invention will tailor the data to be presented in a scientific language that is close to their main domain, thus bridging multidisciplinary scientific gaps.

FIG. 3 depicts the first part of the architecture of the present invention. The architectural approach integrates the RAG model into a parent-child document retrieval framework to optimize the process of information extraction and contextual learning. In this architecture, a corpus of large documents (“parents”) is initially organized by their corresponding scientific domain.

Each parent document is initially processed by a summarization model to extract a comprehensive summary of the document. This summary also includes a list of possible questions that can lead to this document. The documents also undergo Named Entity Recognition (NER) to extract keywords pertaining to them, which goes far beyond the handful of keywords that may be found in a document's meta-data. The meta-data is also used to assign the adequate user group access level for each document. Next, parent documents are subdivided into smaller, more manageable segments (“children”). These child documents serve as fine-grained units for vector embedding, enabling our RAG model to retrieve highly specific contextual information.

When a query is executed, as depicted in FIG. 4, the present invention will perform prompt optimization via LangChain's “MultiQueryRetriever” to generate multiple queries based on user prompt, from various angles. Each query retrieves a distinct set of documents, and by combining the unique results from all queries, we access a broader collection of potentially relevant documents. This multi-perspective approach aims to enhance retrieval and address potential limitations of distance-based methods, resulting in a more comprehensive set of outcomes. It will also cache prompts and their respective responses to improve the model performance.

The hybrid search model of the present invention uses keywords to quickly filter the summaries and NER keywords and grab a body of child documents related to the search query. The ensemble search of the present invention subsequently searches these “child” documents based on their embeddings, pinpointing the most relevant pieces of information for in-context learning and subsequent text generation. This approach allows the present invention to perform a multi-modal search and find the most relevant documents.

The present invention pulls the top k child documents that pertain to the query and use them for subsequent steps. For instance, if a query tests well against four specific child documents (k=4), the model will then retrieve their corresponding parent documents. This hierarchical retrieval mechanism is crucial for instances where fine-grained information is imperative for specific embeddings, but a broader context is needed for the generative model to produce coherent and comprehensive answers. Additionally, the model of the present invention will generate a graph of documents, along with keywords that relate them to other documents. This allows users to interactively explore relationships and discover hidden knowledge.

The combination of keyword matching, child-level specificity and parent-level contextuality is a key feature of the architecture. By utilizing RAG in this multi-level document hierarchy, the present invention achieves a balance between precision and contextual richness, while avoiding hallucination. The child documents enable the model to hone-in on the most relevant information, while the parent documents ensure that the generative aspect of the model has ample contextual data to produce nuanced and insightful responses. This architectural fusion is particularly invaluable for tasks demanding detailed yet coherent information, thereby making it a cornerstone in the DMLLM of the present invention.

Dynamic Embeddings Database: One of the primary innovations of this project is the dynamic embeddings database tailored for each domain. Contrary to the notion of traditional databases as repositories of static information, our database is designed to be fluid and continually updated. It will feature Domain-Specific Embeddings (DSE), produced using state-of-the-art algorithms such as OpenAI's text-embedding-ada-002 (Version 2) model. These embeddings will be generated by routinely ingesting new articles from publicly available open-access sources and commercial publication repositories. Beyond merely capturing current information, the database is engineered to perform knowledge validation and reconcile conflicting pieces of information from different sources, thereby providing a comprehensive, validated, and up-to-date resource for researchers.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts an image of the number of scientific articles published over the past five years.

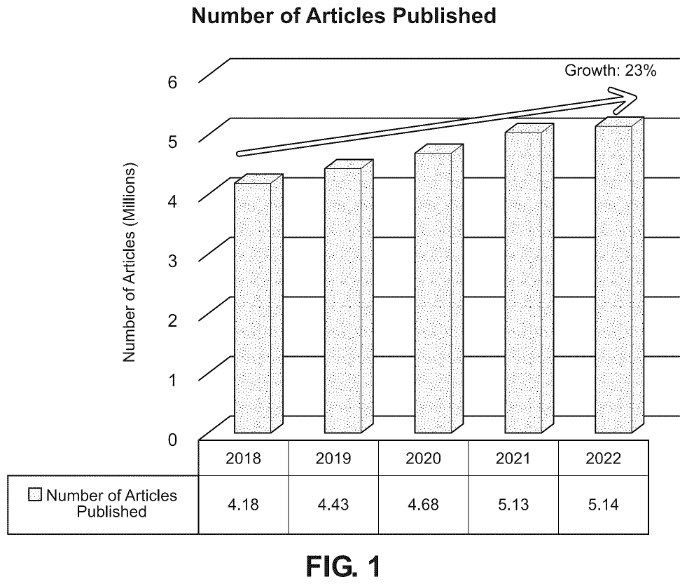

FIG. 2 depicts an image of a schematic representation of intertwined relationship between scientific disciplines.

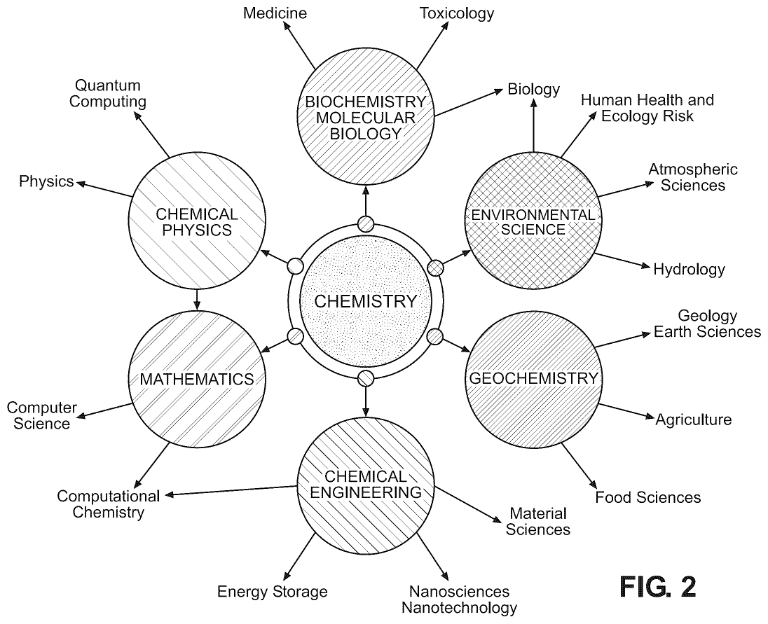

FIG. 3 depicts an image of a proposed data ingest architecture.

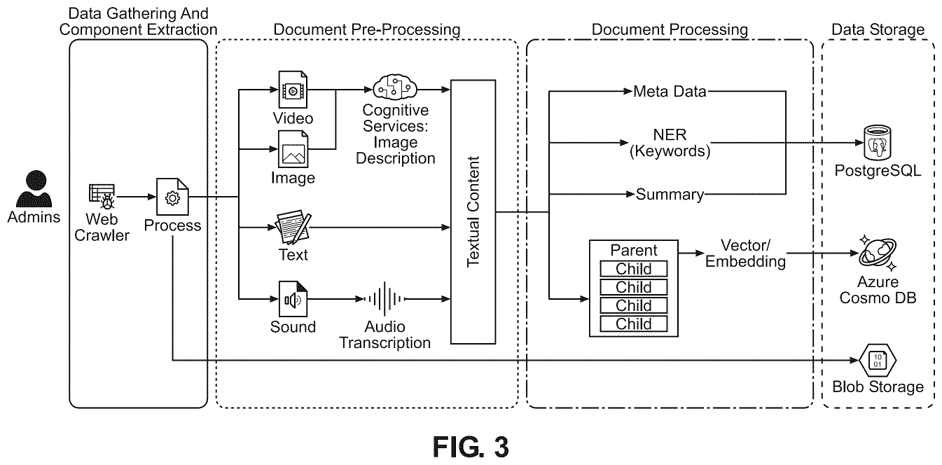

FIG. 4 depicts an image of a hybrid retrieval augmented generation model to be implement in the DMLLM of the present invention.

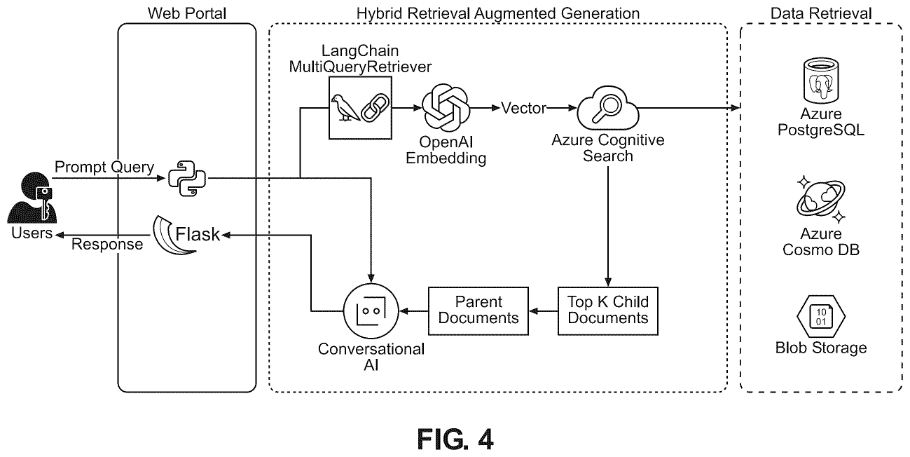

### DETAILED DESCRIPTION OF A PREFERRED EMBODIMENT

### Detailed Steps for Achieving Domain Specific Multi-Modal LLM

The approach to creating a Domain Specific Multi-modal LLM can be further expanded as follows:

### (1) Data Collection

The present invention utilizes an extensive dataset from reputable scientific repositories, both open access and public, as well as subscription-based services. The corpus of the data includes scientific literature, articles, patents, and domain-specific expert interviews across multiple scientific disciplines. Upon acquisition, textual and non-textual content of the document (including scientific diagrams, tables, and charts relevant to the target disciplines) are extracted, automatically summarized and subjected to NER, and persisted along with their meta-data and vector embeddings: (1) Data: acquire, collect and curate scientific literature, research papers, articles, patents, and expert interviews from the chosen disciplines and sources; (2) Textual and Non-Textual Data Extraction: Extract and assemble each document's data including text, images, tables, graphs, chemical structures, mathematical equations, and code snippets; (3) Data Preprocessing: Enrich document descriptors, summary and keywords: (a) Summarization: Create a summary of each document. For non-textual documents, perform a description step prior to summarization. Summary will also include possible questions that are related to this document; (b) Keyword Extraction: Perform NER on each document to create an extended list of keywords pertaining to that document; (c) Vector Embedding: Create vector embeddings for each document (textual and non-textual) via embeddings; (d) Organization and Document Splitting: Organize documents based on their main scientific domain and subcategories. Each document is further split into smaller chunks referred to as Children; and € Storage: Persist each document's metadata, the extracted summary, enhanced keywords and vector embeddings in the database. If permitted by copyright, the original documents can be stored in our Binary Large Object (BLOB) storage.

### (2) User Interface

The user interface is designed to accept queries in multiple formats, including textual and non-textual (e.g., images), and features an explanation mechanism to provide citations or reasoning behind the model's outputs. 1. Query Mechanism: The interface should be capable of accepting both textual and non-textual queries. 2. Explanation Mechanism: Given the scientific nature of the application, the model will also provide citations and explanations for its answers. Not only clicking on the citations will point to the scientific parent document, but it will also bring up and point to the exact location within the parent document where the children that were used to generate the response were pulled from.

### (3) Peer Review

The present invention establishes a mechanism for users to provide feedback for ongoing refinement of the model.

### (4) Legal & Ethical Considerations

The present invention ensures compliance with data privacy regulations and intellectual property laws. It uses documents' metadata to identify proper user access level and limit the use or suggestion of the said documents to users with proper access to the pertaining resources. Continuous monitoring is in place to identify and rectify any biases or inaccuracies in the model's outputs. 1. Data Privacy: Ensure that data used complies with copyright laws, user subscription and access level, and data protection regulations. 2. Bias Monitoring: Take steps to identify and mitigate any biases in the model's responses.

### (5) Evaluation Metrics

It is recognized that traditional evaluation metrics may not fully capture the nuanced performance criteria essential for a domain-specific multi-modal LLM. Therefore, to validate our model's effectiveness against the ground truth, it will implement a multi-faceted set of evaluation metrics, enriched by Reinforcement Learning from Human Feedback (RLHF) integrated into our evaluation strategy.

In terms of the traditional evaluation metrics, the present invention will implement a dual set of evaluation metrics. Intra-disciplinary metrics will assess performance within each individual scientific discipline. Additionally, it will develop or adapt inter-disciplinary KPI metrics to evaluate the model's cross-domain expertise.

Intra-disciplinary: The present invention will validate the model's performance within each domain using accepted reference materials (such as highly reputable and factual articles and textbooks) to serve as ground truth. The self-assessment approach of the present invention generates a set of questions with known answers from the ground-truth references and will evaluate the model's response against them. Additionally, the present invention curates a separate set of questions from the reference materials and judge the model's response against them. This includes scrutinizing the model's reasoning, calculations, utilization of appropriate terminology, and adherence to correct units of measurement.

Inter-disciplinary: The present invention is responsible for creating interdisciplinary evaluation metrics designed to assess the model's ability to seamlessly integrate and apply knowledge from diverse fields. In this capacity, they will assume the role of scientists from one domain and pose targeted questions related to different domains. Their task will involve instructing the model to provide responses using scientific language relevant to their primary domain of expertise.

RLHF: During the pilot testing phase, the present invention will interact with the model and provide feedback on its outputs. This feedback will then be used as a reward signal to fine-tune the model via reinforcement learning. This ensures continuous performance enhancement, closely aligned with real-world expert evaluation.

### 2. The Resulting Product

The DMLLM of the present invention includes a cloud-based subscription service capable of transforming the way scientific data is processed, interpreted, and utilized across various domains. It is designed to streamline research procedures, expedite decision-making processes, and mitigate potential pitfalls, especially benefiting scientists with limited experience in a new field. By aggregating and assimilating the most recent scholarly articles, our tool equips educators with the most current knowledge to enhance the teaching of intricate technical concepts. Simultaneously, it empowers students by facilitating their exploration of technical inquiries through our user-friendly conversational interface.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A system comprising a cloud-based subscription service capable of transforming the way scientific data is processed, interpreted, and utilized across a plurality of different domains, wherein said system comprises:
(a) incorporating a plurality of different forms of data in order to provide a more nuanced understanding of scientific literature; and
(b) a hybrid keyword and semantic search retrieval-augmented generation architecture in order to ingest a plurality of scientific documents and extract text and other data, to build a comprehensive, multi-modal database.

2. The system of claim 1, wherein a plurality of different types of content are then extracted and treated as individual documents.

3. The system of claim 2, wherein said system is able to both process a plurality of queries and understand context, infer intent, and even capture sentiment and a plurality of latent variables.
